(19) United States
(12) Patent Application Publication
(10) Pub. No.: US 2011/0320179 A1
(43) Pub. Date: Dec. 29, 2011

(54) PROCESS MONITORING

(75) Inventors: JOACHIM H. FRANK, Greenwich, CT (US); JOHN WILLIAM ALCORN, Youngsville, NC (US); HUI MING ZHONG, Beijing (CN); QUI ZHOU, Beijing (CN)

(73) Assignee: INTERNATIONAL BUSINESS MACHINES CORPORATION, ARMONK, NY (US)

(21) Appl. No.: 12/824,598

(22) Filed: Jun. 28, 2010

(51) Int. Cl. G06G 7/48

(52) U.S. Cl. 703/6

(57) ABSTRACT

A method for process monitoring may include generating a monitoring-level process model. The monitoring-level process model may be a monitoring-level view of a process and being associated with an implementation-level process model. The implementation-level process model may include a series of implementation-level steps to perform the process. A selection of a monitoring-level step in the monitoring-level process model and a selection of at least one implementation-level step in the implementation-level process model may be received. The implementation-level step(s) may be mapped to the corresponding monitoring-level step(s).

### BACKGROUND

Aspects of the present invention relate to process monitoring, and more particularly to a method, system and computer program product for defining and monitoring processes at a monitoring-level view.

Implementations of real-world processes are usually quite complex. For example, a fulfillment process may involve hundreds of implementation steps that run on one or more process engines. When trying to monitor such processes using conventional process monitoring tools, business users are often overwhelmed by this large number of implementation steps. While business process modeling tools can be used to draw simplified, higher level views of such processes and often are used to obtain a simplified view there is currently no way to link such a view to the implementation, so that process executions can be monitored in real time at the higher abstraction level

### BRIEF SUMMARY

According to one aspect of the present invention, a method for process monitoring may include generating a monitoring-level process model. The monitoring-level process model may include a monitoring-level view of a process and be associated with one or more implementation-level process models. The implementation-level process model may include a series of implementation-level steps to perform the process. A selection of a monitoring-level step in the monitoring-level process model may be received. Also, a selection of at least one implementation-level step in the implementation-level process model may be received. The implementation-level steps may be associated with the monitoring-level step.

According to another aspect of the present invention, a system may include a processor and a tool, operating on the processor, for process monitoring. The tool for process monitoring may allow a monitoring-level process model to be generated, drawn or loaded. The monitoring-level process model may include a monitoring-level view of a process and be associated with one or more implementation-level process model(s), where the implementation-level process model(s) may include a series of implementation-level steps to perform the process. A selection of a monitoring-level step in the monitoring-level process model may be received. Also, a selection of at least one implementation-level step in the implementation-level process model(s) may be received. The implementation-level steps then may be associated with the monitoring-level step.

According to a further aspect of the present invention, a computer program product for process monitoring may include a computer readable storage medium having computer readable program code embodied therewith. The computer readable program code configured for generating, drawings or loading, by a computer system, a monitoring-level process model. The monitoring-level process model may include a monitoring-level view of a process and being associated with one or more implementation-level process model(s). The implementation-level process model(s) may include a series of implementation-level steps to perform the process. The computer readable program code may also include computer readable program code configured for receiving a selection of a monitoring-level step in the monitoring-level process model. The computer readable program code may additionally include computer readable program code configured for receiving a selection of at least one implementation-level step in the implementation-level process model(s). The computer readable program code may further include computer readable program code configured for associating the at least one implementation-level step with the monitoring-level step.

According to a further aspect of the present invention, another method for process monitoring may include generating, drawing or loading a monitoring-level process model that may include a monitoring-level view of a process and may be associated with one or more implementation-level process model(s). The implementation-level process model(s) may include a series of implementation-level steps to perform the process. The method may further include receiving a selection of a monitoring-level step in the monitoring-level process model and receiving a selection of event points in the implementation models that signal a change in status of the monitoring-level step. The change in status of the monitoring-level step is associated with the corresponding event point in an implementation-level process model.

### BRIEF DESCRIPTION OF THE SEVERAL VIEWS OF THE DRAWINGS

The present invention is further described in the detailed description which follows in reference to the noted plurality of drawings by way of non-limiting examples of aspects of the present invention in which like reference numerals represent similar parts throughout the several views of the drawings and wherein:

FIG. 1 is a representation of an overview of process monitoring in accordance with an aspect of the present invention.

FIG. 2 is a flowchart of an example of a method for defining a monitoring-level process model and associating each of its steps with the corresponding steps in one or more implementation-level models in accordance with some aspects of the present invention.

FIG. 3 is an example of a graphical user interface of a tool to define a monitoring-level process model in accordance with an aspect of the present invention.

FIG. 4 is an example of a graphical user interface of a tool to associate each step in a monitoring-level process model with steps in an implementation-level model in accordance with an aspect of the present invention.

FIG. 5 is a flowchart of an example of a method for process monitoring using the monitoring-level process model defined in FIG. 2 in accordance with an aspect of the present invention.

FIG. 6 is an example of a graphical user interface of a method for process monitoring in accordance with another aspect of the present invention.

FIG. 7 is a flowchart of another example of a method for defining a monitoring-level process model and associating each of its step status changes with event points in one or more implementation-level models in accordance with some aspects of the present invention.

FIG. 8 is a flowchart of another example of a method for process monitoring using the monitoring-level process model defined in FIG. 7 in accordance with some aspects of the present invention.

FIG. 9 is a block schematic diagram of an example of a system for process monitoring in accordance with an aspect of the present invention.

### DETAILED DESCRIPTION

As will be appreciated by one skilled in the art, aspects of the present invention may be embodied as a system, method or computer program product. Accordingly, aspects of the present invention may take the form of an entirely hardware aspect, an entirely software aspect (including firmware, resident software, micro-code, etc.) or an aspect combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to aspects of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

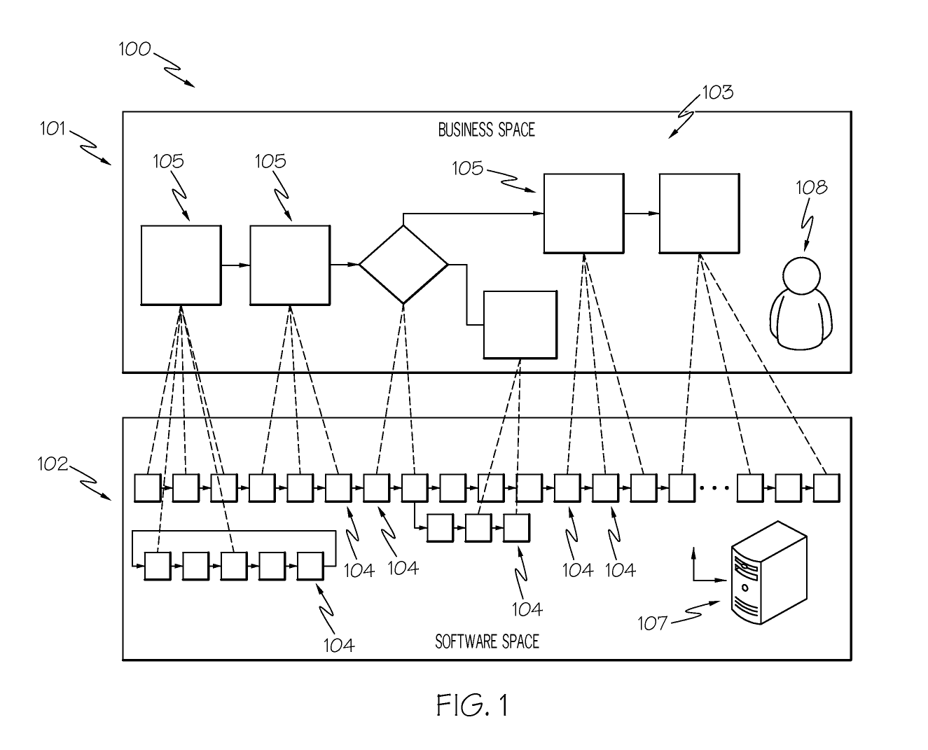

FIG. 1 is a representation of an overview 100 of process monitoring in accordance with some aspects of the present invention. The overview 100 illustrates a business space 101 and software space 102. The business space 101 includes a monitoring-level process 103 that may include a predetermined high-level detail which is viewable by a business user 108, such as a CEO of a company, a business manager of a company, a customer or any other person. The software space 102 includes one or more implementation-level process models that include implementation-level steps 104 which can run on one or more process engines, messaging engines, or other business integration software platforms 107 to implement a process. According to one aspect, the implementation-level steps 104 may make up a software program to implement the process.

The process that is to be monitored can be any process where a user desires to monitor the status of the process. The process can be a business process, such as fulfilling orders and shipping goods, or the process can be a non-business process, such as a person monitoring flights, tracking a package, monitoring the status an insurance claim, and the like.

The monitoring-level process 103 may include a series of monitoring-level steps 105 that may be an outside-to-in view or a top-down view of the process to be monitored. According to some aspects, the monitoring-level process may be a simplified overview or an abstract representation of the implementation-level steps 104. The monitoring-level process 103 may not be a portion of the software program used to actually implement the process and thus, may not be executing instructions using the process engines, messaging engines, or other business integration software platforms 107, according to some aspects.

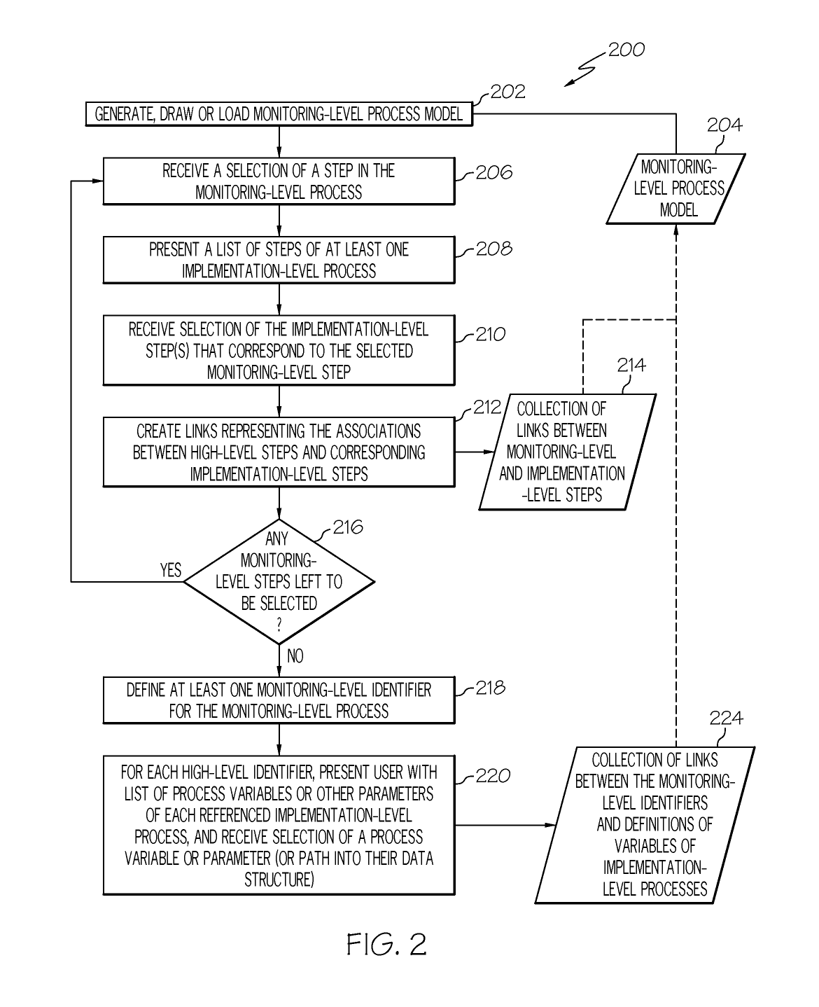

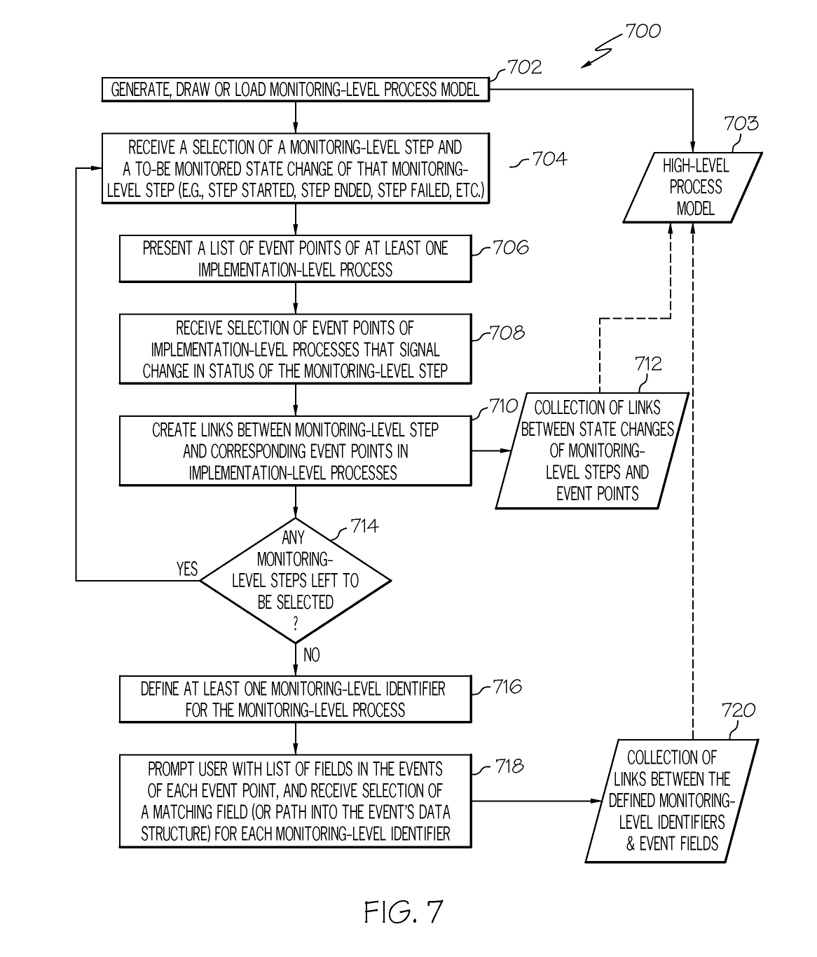

As is discussed later in FIGS. 2 and 7, steps 105 of the monitoring-level process 103 may be associated with one or more implementation-level steps 104 so as to provide a collective representation of the status of the associated implementation-level steps 104. Such association is illustrated in FIG. 1 via dotted lines connecting the monitoring-level steps 105 with the implementation-level steps 104.

An example of a monitoring-level process includes selling and delivering of goods. Specifically, a monitoring-level process for selling and delivering goods may include a seven-step process: 1) receive an order from customer; 2) validate order and customer information; 3) check inventory; 4) fill order; 5) ship goods; 6) send invoice; and 7) receive payment. This monitoring-level process has seven steps, but may have hundreds of implementation-level steps implementing the process. For example, for the first monitoring-level step of “receiving an order from a customer,” there may be several implementation-level steps required to complete the monitoring-level step, such as “call graphical user interface to allow user for inputting order,” “open IP portal,” “present graphical user interface to user,” “receive data packets from graphical user interface,” “store IP address of customer,” “transmit data packets to web server,” “unpack data packets from web server,” “input order information into proper variables,” “create order number,” “create order entry into database,” “store order number into order entry on order database,” “store other order data into order entry on order database,” “determine if any errors have occurred,” etc. Because these steps are implementation-level and thus, may have a level of detail that a business person may not desire to monitor, a monitoring-level view (e.g., “receive order from a customer”) may be instead more desirable.

Another example of the above-mentioned monitoring-level step may include “check inventory” which may require a large number of implementation-level steps or interactions with humans and systems. These implementation steps may include looking up storage bin numbers, finding alternative items or initiating replenishment when goods are not in stock, calling the customer to see if a partial order can be shipped, etc. Yet, an operations manager tracking order fulfillment, or an executive asking for status, may not be interested in that level of detail. His view of the process is the simple seven-step flow outlined above, and he may desire to monitor the process at that abstraction level.

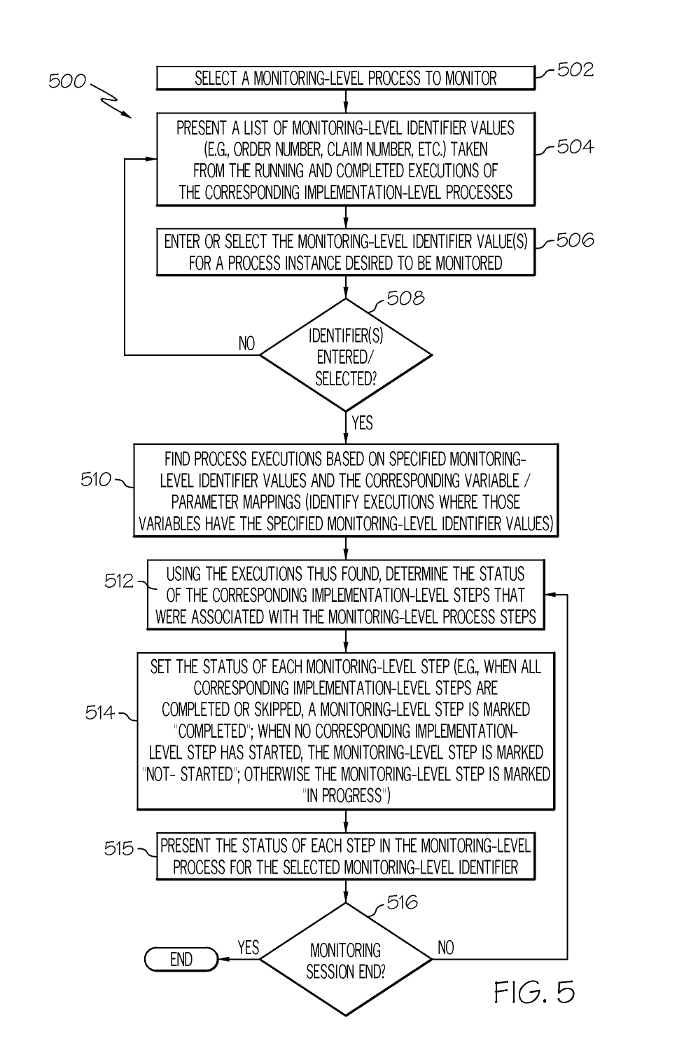

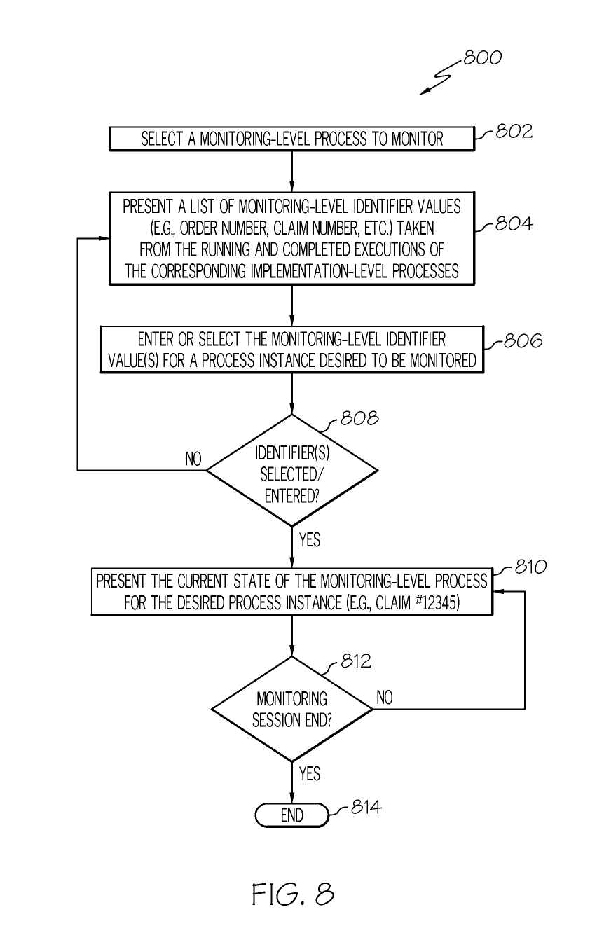

In one aspect, methods, systems and computer program products described herein enables users to configure business process monitoring outside-to-in starting from the business user's perspective. This allows for reconciliation of a monitoring-level view of processes with the possibility of a much more detailed implementation. The methods, systems and computer program products, as described herein, may offer a side-by-side view of the monitoring-level process (e.g., business user's view) and a list of processes and activities implementing the monitoring-level process (e.g., implementation-level view). The methods, systems and computer program products also allow users to specify which implementation-level activities correspond to each step in the monitoring-level process model. This information is used at runtime to show progress at the higher abstraction level, such as when the first implementation-level steps that corresponds to “check inventory” starts, the corresponding monitoring-level step is considered in progress, etc. A more detailed description of some aspects is provided below with regard to FIGS. 2-9. There are two tools described herein: (1) a first tool that allows a user to define/draw a monitoring-level process and associate the monitoring-level process steps with implementation-level steps; whereby an exemplary operation of the first tool is illustrated by the flow charts in FIGS. 2 and 7; (2) a second tool that uses the step associations created to actually monitor running processes, and present their status using the monitoring-level view; the logic of the second tool is illustrated in the flow charts of FIGS. 5 and 8.

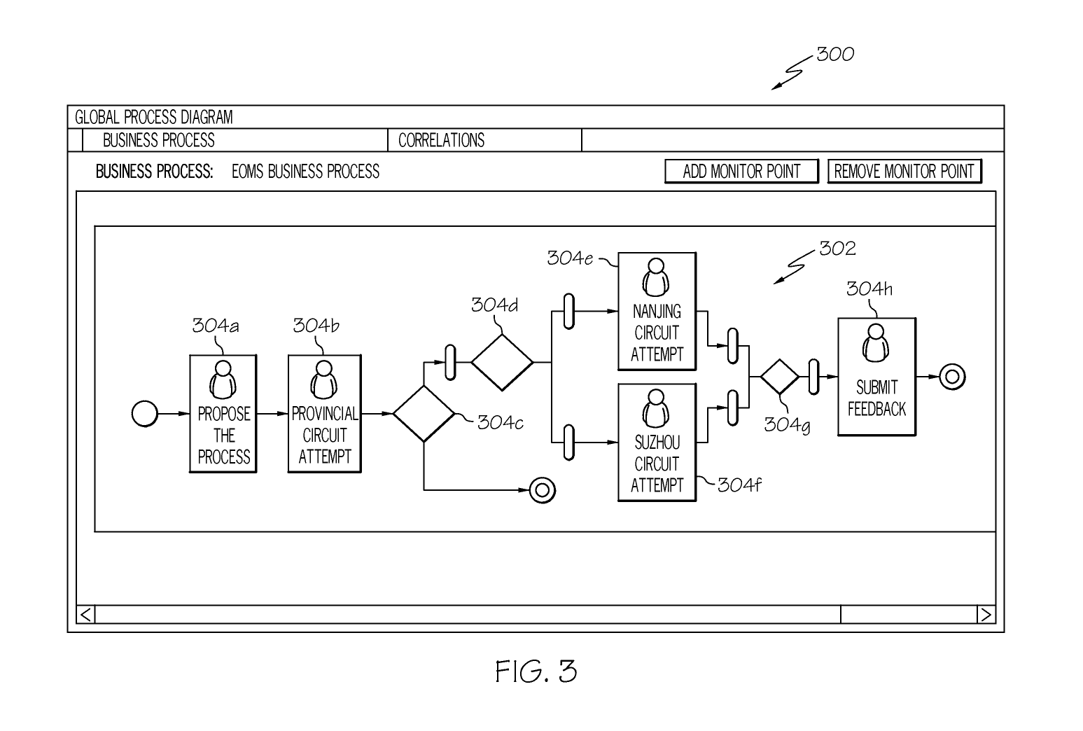

FIG. 2 is a flowchart of an example of a method 200 for defining a monitoring-level process model in accordance with an aspect of the present invention. In block 202, a monitoring-level process model 204 may be generated. The monitoring-level process model 204 may be a model which includes the steps of the monitoring-level process. As will be discussed later in blocks 212 and 220, the monitoring-level process model 204 may include data from a a collection of links 214 and a database of variables associated with correlated identifiers 224. An example of a monitoring-level process model 204 is illustrated in FIG. 3, which is discussed below.

FIG. 3 is an example of a graphical user interface 300 of tool that allows for creating and viewing a monitoring-level process model 302 in accordance with an aspect of the present invention. The monitoring-level process model 302 may be related to a large number (e.g., hundreds or more) implementation-level steps (not shown). For example, the monitoring-level process 302 of FIG. 3 illustrates eight steps 304a-h throughout the monitoring-level process 302, which is easier to monitor than the large number of implementation-level steps. The monitoring-level process 302 of FIG. 3 is an example of the monitoring-level process 103 previously discussed with respect to FIG. 1.

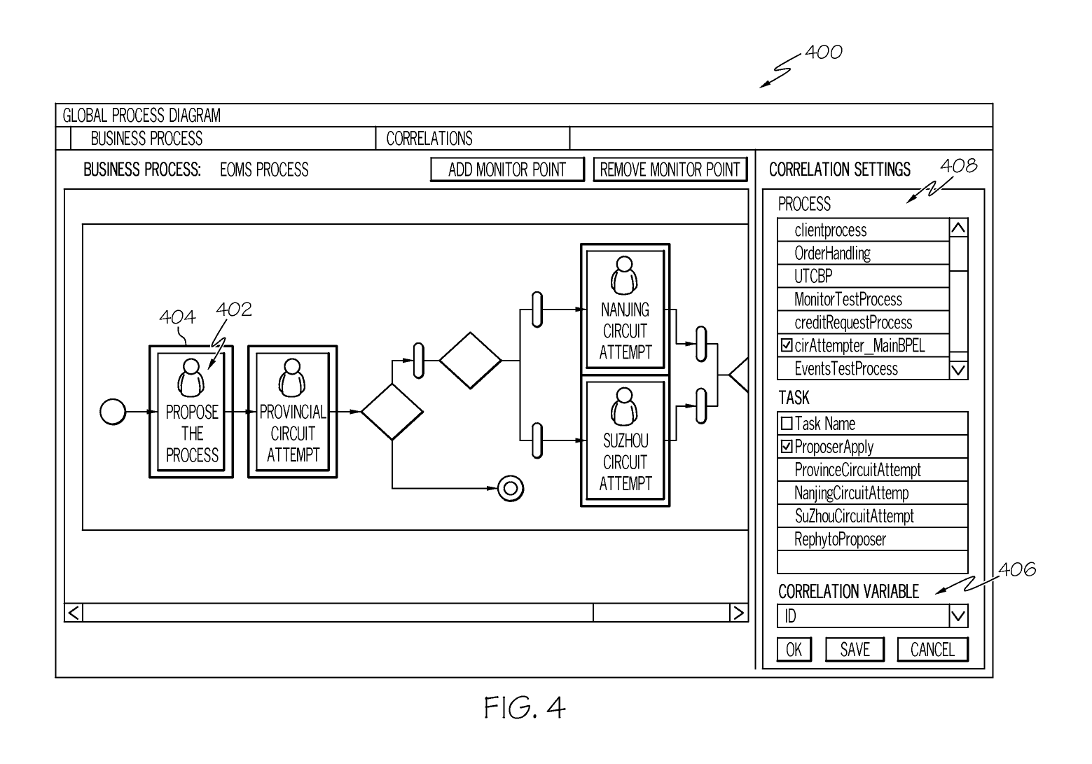

Referring back to FIG. 2, in block 206, a selection of a step in the monitoring-level process by a user is received by a tool that, according to an aspect of this invention, assists the user with configuring a process monitor. The step may be selected in any manner, such as the at a drop-down menu, checking a checkbox associated with the step, placing a box around a graphical illustration of the step, etc. As illustrated in FIG. 4, a box 404 may be dragged around the step 402 (or steps) which the user selects from a graphical user interface 400.

In block 208 of FIG. 2, a list of steps of at least one implementation-level process is presented to the user using a graphical user interface to allow for selection of one or more implementation-level processes.

In block 210, a selection of the implementation-level step(s) that corresponds to the selected monitoring-level step is received by the system. These implementation-level step(s) correspond to the selected monitoring-level step discussed above in block 206 so that, when viewing the monitoring-level process, the monitoring-level step will reflect or indicate the status of the implementation-level step(s).

In block 212, a collection of links 214 is created that indicates the associations between the monitoring-level step and the corresponding implementation-level step(s) similar to that previously described with reference to FIG. 1. These links 214 effectively associate the selected implementation-level step(s) with the selected monitoring-level step. The collection of links 214 may be stored as part of the monitoring-level process model 204 as illustrated in FIG. 2 by dotted lines. According to an alternate aspect, instead of mapping a monitoring-level step to a set of implementation-level steps, one can associate the start and end of a monitoring-level step with the beginning and end of implementation-level steps.

In decision block 216, a determination may be made as to whether any monitoring-level steps are left to be associated with implementation-level steps. If all monitoring-level steps that have been desired to be associated have been associated, then the method 200 may continue to block 218; otherwise, the method 200 may return to block 206 where the next monitoring-level process step is selected and processed similar to that discussed above with regards to blocks 208-212.

In block 218, at least one monitoring-level instance identifier for the monitoring-level process is identified or selected. A monitoring-level instance identifier may relate to a parameter that will identify one or more specific instances of the monitoring-level process. For example, if a monitoring-level process is configured to illustrate selling and delivering goods, a monitoring-level instance identifier may be a specific order number, which allows a manager to view the status of a single customer order associated with the order number. It should be understood that a single monitoring-level instance identifier may be associated with more than one instance of a monitoring-level process, for example when customer orders are bundled. Consequently, according to some aspects, more than one monitoring-level instance identifier may be required to uniquely identify a monitoring-level process instance. For example, more than one monitoring-level instance identifier may be needed for a process of tracking or monitoring airplane flights, where both the flight number and the flight date would be needed in order to pinpoint the “instance” of a flight.

In block 220, a user is presented with a list of process variables, or other parameters, such as fields of input or output messages, of each referenced implementation-level process, and a selection of a process variable or parameter (or path into a variable or parameter if those have a complex structure) corresponding to each monitoring-level instance identifier is received. The selected process variable or parameter may be the variable or parameter which defines the data and/or instance(s) that the monitoring-level process will present. For example, if a user desires to monitor customer orders, then the user needs to define a way to identify which customer orders the user desires to view. As such, the user may decide that she wants to identify customer orders by the order number and in that event, the user will need to indicate to the monitoring-level process model that the process variable is the “order number.” And since the process variable has been set to be the order number, the user can then simply tell the system the specific order number that the user desires to monitor and the system will then retrieve the corresponding information associated therewith, by using the process variable or parameter that has been selected to correspond to “order number”, to find the implementation-level process instances for a specific order. For example, assuming the user has selected the monitoring-level instance identifier to be “order number,” and selected a process variable “orderNo” as the corresponding process variable, when the user selects a specific order number (e.g., order #1308), the user then will view the status of the order of that specific order number in the monitoring-level process. If the user instead would like to view all orders by “customer ID,” the user should indicate a process variable as “customer ID.” An example of selecting the process variable is illustrated in FIG. 4 where the “correlation variable” 406 is the process variable and the drop-down arrow allows for its selection amongst all variables of the implementation-level process currently highlighted in the “Process” menu 408. It should be understood that a process variable or other parameter may be selected for each monitoring-level instance identifier chosen in the monitoring-level process model. It should be noted that the implementation-level steps are shown in the “Task” window of FIG. 4, where the “PropserApply” is a single implementation-level step that is selected for the selected monitoring-level process (i.e., “cirAttemper_MainBPEL”).

FIG. 5 is a flowchart of an example of a method 500 for process monitoring using the monitoring-level process model defined in FIG. 2 in accordance with an aspect of the present invention. In block 502, a monitoring-level process that a user wishes to monitor is selected. In one aspect, only a monitoring-level process can be selected.

In block 504, a list of monitoring-level instance identifiers may be presented to the user. These monitoring-level instance identifiers may be taken from the currently running or completed executions of the corresponding implementation-level processes, where the values of the process variables or parameters identified in block 220 may be used to establish this list. In block 506, at least one monitoring-level identifier is selected, or entered manually if a selection has not been provided, for the desired monitoring-level process. The monitoring-level identifier effectively selects which instance of the monitoring-level process to view. For example, as previously discussed, a selection of a monitoring-level identifier could be an “order number” in the case of monitoring the status of purchase orders, which will allow a user to select a specific “order number” (or group of order numbers) to monitor at a time. In block 508, a determination is made as to whether an identifier is selected. If not, the method 500 returns to blocks 504 and 506; otherwise the method 500 may proceed to block 510.

In block 510, the system selects the corresponding process executions based on specified monitoring-level identifier(s) values and the corresponding variable selections, previously discussed in method 200 of FIG. 2. The status of the corresponding process executions is used to present data to the monitoring-level process model and allow the current execution state of one or more instances to be displayed by the monitoring-level process view.

In block 512, a determination is made as to the status of the implementation-level steps that were mapped to the monitoring-level process steps. Once the status of the implementation-level steps is determined, the status of the monitoring-level process steps can then be derived and updated in the monitoring-level process view.

In block 514, the status of each monitoring-level step is set in the monitoring-level process model. For example, when all implementation-level steps for a corresponding monitoring-level step are completed or skipped, then that corresponding monitoring-level step is marked as “completed.” When none of the implementation-level steps corresponding with a monitoring-level step has been started, then that corresponding monitoring-level step is marked as “not started.”When at least one of the implementation-level steps corresponding with a monitoring-level step has been started, but not all such steps have been completed, then that corresponding monitoring-level step is marked as “in progress.”

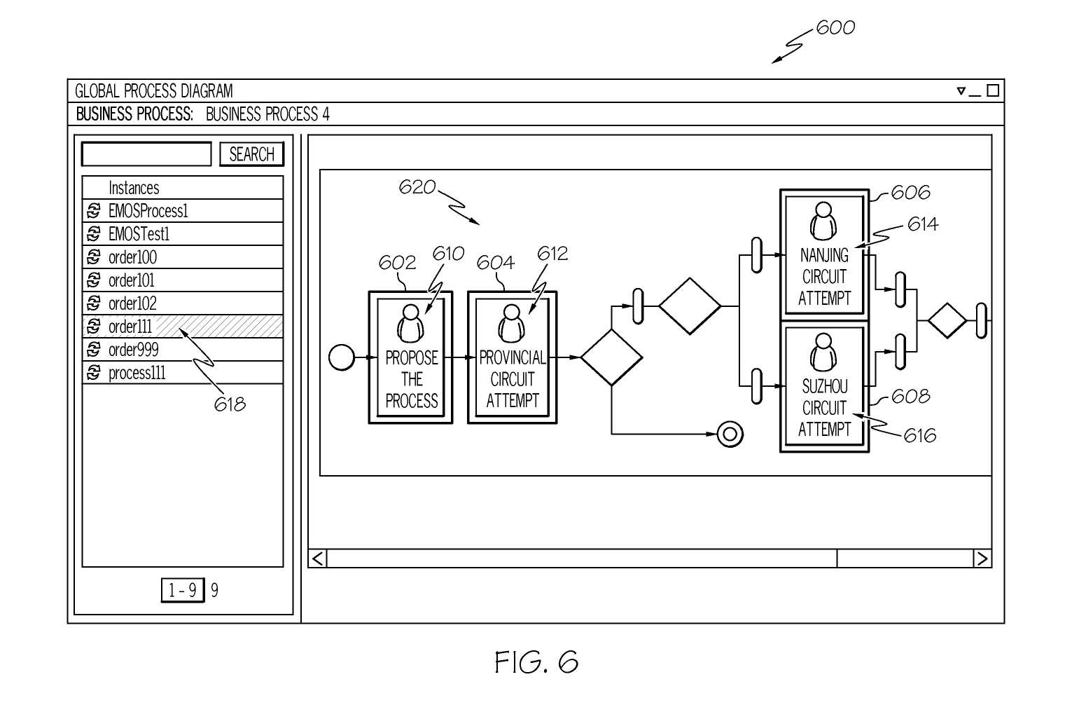

These representations are then presented to the user visually (or possibly audibly) through the monitoring-level process, as described in block 515. The status of each step of the monitoring-level process may be indicated in any manner, such as by changing the color of box around each monitoring-level step to indicate the status. This process can be viewed in FIG. 6 which is discussed in more depth later.

In decision block 516, a determination is made as to whether the monitoring session has ended. Such determination may be made, for example, if the user logs out or some other indication is received indicating to end the monitoring session. If block 516 determines that the monitoring session has ended the method 500 continues to block 518 where the method 500 ends; otherwise, the method 500 may proceed back to block 512 to repeat blocks 512, 514 and 515, all of which have previously been discussed.

FIG. 6 illustrates the monitoring-level process model being monitored in accordance with some aspects of the present invention. FIG. 6 illustrates the status of each previously-defined monitoring-level step 610, 612, 614, 616 for a particular business instance identifier 618. In order to monitor the monitoring-level process 620 of a specific instance, the user selects the business instance identifier 618, which, in the example of FIG. 6 is an order number (i.e., order number #111) of a shipped good. The monitoring-level process 620 then illustrates a graphical representation of the current status of order number #111. As illustrated, monitoring-level steps 610, 612, respectfully, have been completed and the status of these monitoring-level steps 610, 612 is indicated as completed by changing the color of boxes 602, 604, for example, from blue to green. Using boxes around monitoring-level steps for status indication is just one example of showing their status; alternative methods include changing the fill color; changing the line style of the step's boundary; adding written labels (‘NOT STARTED’, ‘IN PROGRESS’, ‘COMPLETED’); etc. With regard to monitoring-level steps 614, 616, the status of these monitoring-level steps 614, 616 is indicated by blue boxes 606, 608 which signify the ‘not started’ status using a different color (e.g., blue). This presents a visual indication to the user so that the user can quickly assess which monitoring-level steps have been completed, which monitoring-level steps are in progress, and which monitoring-level steps have not yet been started for order number #111. It should be noted that the indication of status change need not be a color change or event a visual indication, the status change may be presented to the user in any other way, such as via an audible alert, graying-out an icon that represents the monitoring-level step, sending a message using the Intranet (e.g., a text message or email message to a mobile wireless device), and/or any other way to present a status change of a monitoring-level step.

Notably, as previously mentioned with regard to FIG. 4, the boxes are drawn around each monitoring-level process step respectfully, are used to predefine which implementation-level steps correspond with each monitoring-level process step. In FIG. 6, similar-looking boxes are used to indicate the status of the monitoring-level process that is monitored. However, it should be understood that the boxes of FIGS. 4 and 6 are not necessarily the same boxes even though they may look similar in the illustrations. Indeed, the status of the monitoring-level steps of FIG. 6 may be illustrated using status indicators other than boxes and/or the monitoring-level steps of FIG. 4 may be associated with each respective implementation-level step by means other than boxes.

FIG. 7 is a flowchart of an example of a method 700 for defining a monitoring-level process model in accordance with another aspect of the present invention. In block 702, a monitoring-level process model 703 is drawn, loaded, generated in a tool. In block 704, a selection of a step in the monitoring-level process and a to-be-monitored state change of that step is received by the tool. In block 706, a list of event points of at least one implementation-level processes is presented to the user for selection. Event points may relate to any event or happening in the implementation-level process. In some aspects, the event points signify a start or end of one or more implementation-level steps. Examples of event points may be: a start/end to a step(s) has occurred, a result or goal has been accomplished, a failure has occurred, an amount of time has elapsed, a message or signal has been received, or any other indication that an event has occurred. For example, in the previously presented example of selling and delivering goods, an event point may be that the goods have loaded onto the dock indicating that the monitoring-level step of shipping goods has begun. Event points may occur anywhere along the implementation-level process and are not limited to occurring at a specific implementation-level step.

In block 708, a selection is received of event points that signal a change in status (e.g., start, end, pending, etc.) of the currently selected monitoring-level step. For example, if an event point indicates that a product has been loaded onto a delivery vehicle, then the monitoring-level step of “deliver goods” will be marked as “started.”

In block 710, a collection of links 712 is created between monitoring-level step status changes (e.g., step 1 start, step 1 end, step 2 start, etc.) and corresponding event points. Those links may be stored as part of the monitoring-level process model 703.

In block 714, a determination is made as to whether any monitoring-level steps are left to have event points selected that indicate their status changes. If so, the method 700 may proceed back to block 704; otherwise, the method 700 may proceed to block 716.

In block 716 at least one monitoring-level instance identifier for the monitoring-level process is specified. This is similar to block 218 of FIG. 2 which was previously discussed.

In block 718, the user is prompted with a list of fields in the events of each event point. In response, the system receives a selection of a field (or path into the event's data structure) that corresponds to each monitoring-level instance identifier. The event field selections that for each monitoring-level instance identifier are stored in a database 720, and optionally may be stored as part of monitoring-level process model 703 as indicated by the dotted line and FIG. 7.

FIG. 8 is a flowchart of an example of a method 800 for process monitoring using the monitoring-level process model defined in FIG. 7 in accordance with some aspects of the present invention. In block 802, a monitoring-level process to monitor is selected. In block 804 the user is presented a list of monitoring-level identifiers taken from the currently monitored monitoring-level process executions. These process executions may be known and tracked based on events received from the event points selected in method 700. In block 806, the monitoring-level identifier(s) for the monitoring-level process desired to be monitored is selected. In block 808, a determination is made as to whether an identifier was selected. If not, the method 800 returns to blocks 804 and 806 until a monitoring-level identifier is selected. When a monitoring-level identifier is selected, the method 800 may proceed to block 810 where the user is presented the current state of the monitoring-level process for the monitoring-level process instance associated with the selected monitoring-level identifier(s). In block 812 a determination is made as to if the monitoring session is ended, such as if the user has logged out the monitoring session. If the monitoring session has not ended, the method 800 returns to block 810; otherwise, the method 800 may end at block 814.

According to some aspects, process monitoring may extend beyond mapping implementation-level steps to monitoring-level steps and tracking the monitoring-level process. For example, a frequent monitoring goal may be to measure the time it takes to get from one point in the monitoring-level process to a later point, where such a “path” can comprise multiple implementation-level steps. A business user could define two points in the monitoring-level process graph as representing the start and end of such path and instruct the system to monitor the time between these points. Furthermore, a user could highlight a decision in the monitoring-level process, and instruct the system to monitor the branching probabilities. Using such “point-and-click” techniques of specifying monitoring goals is dependent on having a view of the process that business users can understand and relate to.

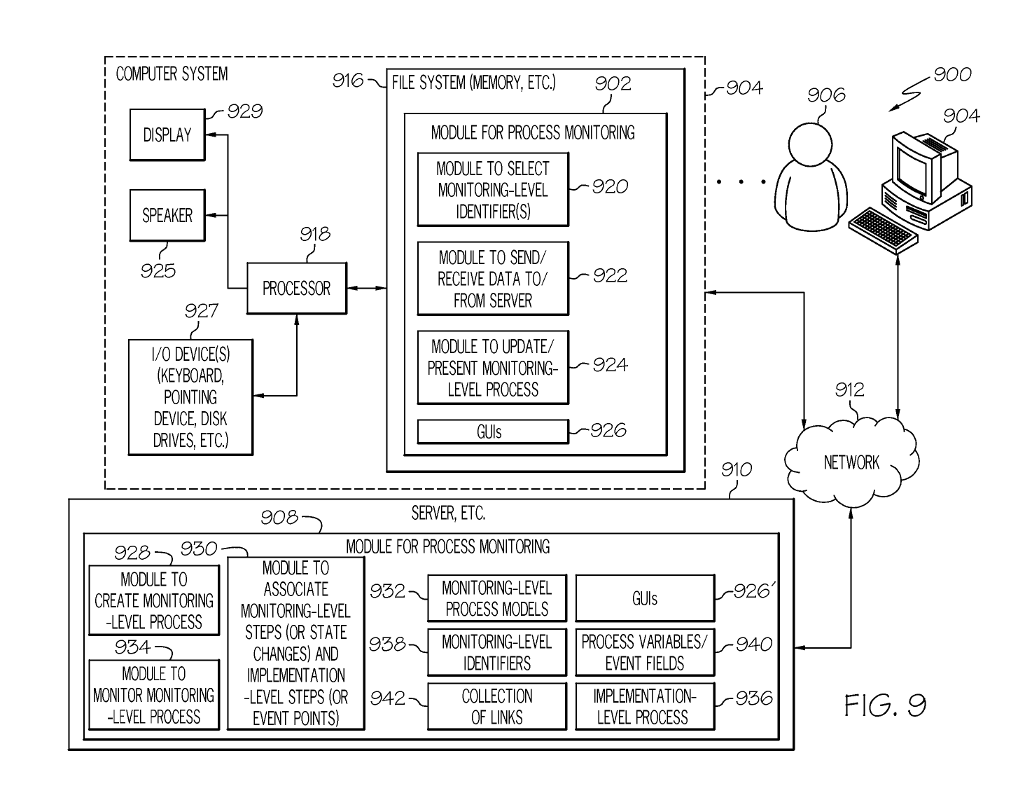

FIG. 9 is a block schematic diagram of an example of a system 900 for process monitoring in accordance with an aspect of the present invention. The methods 200, 500, 700, and/or 800 of FIGS. 2, 5, 7 and 8, respectively, may be embodied in or performed by the system 900.

The system 900 may include a module for a process monitoring 902 operable on a computer system 904, or similar device of a user 906 or client. Alternatively, or in addition to the process monitoring module 902 on the user's computer system 904 or client, the system 900 may include a server process monitoring module 908 operable on a server 910 and accessible by the user 906 or client 904 via a network 912. The methods 200, 500, 700, 800 may be embodied in or performed by the process monitoring module 902 and/or the server process monitoring module 908. In one aspect, the methods 200, 500, 700, 800 may be wholly performed by the process monitoring module 902. In another aspect of the invention, the methods 200, 500, 700, 800 may be wholly performed by the server process monitoring module 908. In a further aspect of the present invention, some of the features or functions of the methods 200, 500, 700, 800 may be performed by the process monitoring module 902 on the user's computer system 904 or client and other features or functions of the methods 200, 500, 700, 800 may be performed on the server process monitoring module 908.

The network 912 may be the Internet, a private network or other network that allows for interaction between the server(s) 910 and the computer system 904. Each computer system 904 may be similar to the exemplary computer system 904 and associated components illustrated in FIG. 9.

The user's computer system 904 may include a speaker 929 and a speaker 925 or speaker system. The display may present the monitoring-level process model when monitoring a process as described herein. Any GUIs associated with the virtual world viewers may also be presented on the display 929. The speaker 925 may present any voice or other auditory signals or information to the user 906.

The user's computer system 904 may also include one or more input devices, output devices or combination input and output device, collectively I/O devices 927. The I/O devices 927 may include a keyboard, computer pointing device or similar means to control operation of avatars and VW viewer features and to enter information into various GUIs as described herein. The I/O devices 927 may also include disk drives or devices for reading computer media including computer-readable or computer-operable instructions.

The process monitoring module 902 may be stored on a file system 916 or memory of the computer system 904. The process monitoring module 902 may be accessed from the file system 916 and run on a processor 918 associated with the computer system 904.

The process monitoring module 902 may include a module to select monitoring-level identifier(s) 920 (hereinafter “identifier selection module”). The identifier selection module 920 allows presentation of a list of monitoring-level identifiers 938 and allows the user to input into the computer system 904 an entry or selection of at least one monitoring-level identifier. Input of the monitoring-level identifier(s) may be allowed via any manner, such as presenting one or more interactive GUIs or the like.

The process monitoring module 902 may include a module to send and receive data to/from server 922 (hereinafter “send/receive module”). The send/receive module 922 allows for data to be exchanged between the computer system 904 and the server 910 and may call one or more modules in the server 902.

The process monitoring module 902 may also include a module to present/update monitoring-level process 924. As previously discussed, a monitoring-level process may be presented to the user and may be constantly being updated with the status of the monitoring-level steps via the module to present/update monitoring-level process 924. The module to present/update monitoring-level process 924 also may control presentation of the monitoring-level process to the user, as previously discussed with regard to FIG. 5.

The process monitoring modules 902, 908 may present one or more predetermined GUIs 926, 926′ to permit the monitoring-level process model to be drawn, loaded, generated, configured and/or monitored. The GUIs 926, 926′ may include a GUI to allow the user to define the monitoring-level process monitor, as previously discussed. These GUIs 926, 926′ may be predetermined and presented in response to the user indicating the user would like to enter/select data, information and/or settings. The predetermined GUIs 926, 926′ may be generated by the process monitoring module 902, 908 and may be presented on the display 929 of the computer system 904. The GUIs 926, 926′ may also include GUIs to permit the user to select monitoring-level instance identifier(s) and monitor the monitoring-level process, as previously discussed.

The server process monitoring module 908 may include a module to create monitoring-level process model 928, module to associate monitoring-level and implementation-level model steps (“mapping module”) 930, monitoring-level process models 932, module to monitor monitoring-level process 934, implementation-level process models 936, definitions of monitoring-level instance identifiers 938, and relationships of those with process variables or event fields 940. These modules 928, 930, 932, 934, 936, 938, 940 of the server process monitoring module 908 may be included within the process monitoring module 902. For example, the functionality of modules 928, 930, 932, 934, 936, 938, and/or 940 of the server process monitoring module 908 may be performed on the server process monitoring module 908 and/or on the process monitoring module 902 of the user's computer system 904.

In an aspect of the present invention, some of the features or functions of the methods 200, 500, 700, 800 may be performed within the process monitoring module 902 on the user's computer system 904 and other features or functions of the methods 200, 500, 700, 800 may be performed within the server process monitoring module 908 on the server 910.

The server process monitoring module 902 may include the module to create monitoring-level process model 928. As previously discussed with regard to blocks 202 and 702 of FIGS. 2 and 7, respectively, the monitoring-level process models 932 may be drawn, loaded, or generated and stored. The module to create monitoring-level process model 928 may perform this function. The model to create monitoring-level process model 928 may also modify/update the monitoring-level process models 932 to include a collection of links 942 and references to process variables/event fields 940. The link collection 942 and process variables/event fields references 940 relate to the collections of links 214, 712 and references to variables or other parameters associated with monitoring-level instance identifiers 224 and/or references to event fields associated with monitoring-level instance identifiers 724, which was previously discussed with regard to FIGS. 2 and 7.

The server process monitoring module 902 may also include the mapping module 930. The mapping module 930 allows for associating steps or event points of an implementation-level process 936 to the monitoring-level process model 932, as previously discussed with regard to blocks 212 and 710 of FIGS. 2 and 7, respectively. This also allows for defining one or more monitoring-level instance identifiers and associating them with corresponding process variables or event fields.

The server process monitoring module 902 may additionally include the module to monitor a monitoring-level process 934. The module to monitor a monitoring-level process 934 allows a user to monitor a selected monitoring-level process 932 by entering or selecting specific values for monitoring-level instance identifiers 938, as previously described by FIGS. 5 and 8. The module to monitor a monitoring-level process 934 receives input from the monitoring-level models 932 and monitoring-level instance identifiers 938 as well as other modules on the server module for process monitoring 908. The module to monitor a monitoring-level process 934 sends data to the module to update/present monitoring-level process views 924 on the user's computer 904, where the user can monitor the monitoring-level process associated with the selected monitoring-level instance identifier.

The server process monitoring module 902 may also include implementation-level processes 936. The implementation-level processes 936 contain a plurality of implementation-level steps, each of which may relate to software program(s) which contain computer program code to perform one or more functions for the process to be monitored. The implementation-level processes 936 allow for programs to receive inputs manually and/or automatically and are not to be limited to only software programs but any other means which can achieve a function for the process to be monitored. For example, an implementation-level step could consist of a person scanning packages being loaded on a truck, in which case the scanner events may represent the event points associated with state transitions of steps in a monitoring-level logistics process.

The flowcharts and block diagrams in the Figures illustrate the architecture, functionality, and operation of possible implementations of systems, methods and computer program products according to various aspects of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems which perform the specified functions or acts, or combinations of special purpose hardware and computer instructions.

The terminology used herein is for the purpose of describing particular aspects only and is not intended to be limiting of aspects of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to aspects of the invention in the form disclosed. Many modifications and variations will be apparent to those of ordinary skill in the art without departing from the scope and spirit of aspects of the invention. The aspect was chosen and described in order to best explain the principles of aspects of the invention and the practical application, and to enable others of ordinary skill in the art to understand aspects of the invention for various aspects with various modifications as are suited to the particular use contemplated.

Although specific aspects have been illustrated and described herein, those of ordinary skill in the art appreciate that any arrangement which is calculated to achieve the same purpose may be substituted for the specific aspects shown and that aspects of the invention have other applications in other environments. This application is intended to cover any adaptations or variations of the present invention. The following claims are in no way intended to limit the scope of aspects of the invention to the specific aspects described herein.

What is claimed is:

1. A method for process monitoring, the method comprising:
generating, by a computer system, a monitoring-level process model, wherein the monitoring-level process model comprises a monitoring-level view of a process and being associated with an implementation-level process model, and wherein the implementation-level process model comprises a series of implementation-level steps to perform the process;
receiving a selection of a monitoring-level step in the monitoring-level process model;
receiving a selection of at least one implementation-level step of an implementation-level process model; and
associating the at least one implementation-level step with the monitoring-level step.

2. The method of claim 1, further comprising:
receiving a selection of one or more monitoring-level steps in the monitoring-level process model; and
receiving a selection of one or more implementation-level steps in the implementation-level process model for each of the one or more monitoring-level steps;
mapping the one or more implementation-level steps to the one or more monitoring-level steps.

3. The method of claim 1, further comprising:
identifying at least one monitoring-level instance identifier for the monitoring-level process;
presenting a list of definitions of process variables or other parameters of each implementation-level process; and
receiving a selection of a process variable or other parameter of each implementation-level process, for each monitoring-level instance identifier.

4. The method of claim 3, wherein the monitoring-level process model is capable of displaying the state of an instance of this process, and wherein the monitoring-level instance identifier comprises an identifier which indicates what monitoring-level process instance to be displayed.

5. The method of claim 4, further comprising presenting the monitoring-level process instance to a user by displaying the status of steps of a monitoring-level process instance to the user.

6. The method of claim 1, further comprising presenting a list of implementation-level steps of the implementation-level process model, the list of implementation-level steps comprising the at least one implementation-level step.

7. The method of claim 1, wherein the implementation-level steps are being run in a software engine, and wherein the monitoring-level process comprises a business overview of the process so that the monitoring-level process is not run in the software engine.

8. The method of claim 1, wherein each step of the monitoring-level process is viewed as a graphical representation of one or more implementation-level steps.

9. The method of claim 1, further comprising presenting the monitoring-level process to a user to display a status of steps the monitoring-level process to the user.

10. A system comprising:
a processor; and
a module, operating on the processor, for process monitoring, the module configured to:
generate, by a computer system, a monitoring-level process model, wherein the monitoring-level process model comprises a monitoring-level view of a process and being associated with an implementation-level process model, and wherein the implementation-level process model comprises a series of implementation-level steps to perform the process;
receive a selection of a monitoring-level step in the monitoring-level process model;
receive a selection of at least one implementation-level step in the implementation-level process model; and
associate the at least one implementation-level step with the monitoring-level step.

11. The system of claim 10, further comprising:
a module to identify at least one monitoring-level instance identifier for the monitoring-level process;
a module to present a list of definitions of process variables or other parameters of the implementation-level processes; and
a module to receive a selection of a process variable or other parameter of each implementation-level process, for each monitoring-level instance identifier.

12. The system of claim 10, further comprising a module to present a list of implementation-level steps of the implementation-level process model, the list of implementation-level steps comprising the at least one implementation-level step.

13. The system of claim 10, further comprising a display to present the monitoring-level process to a user to display a status of steps the monitoring-level process to the user.

14. A computer program product for process monitoring, the computer program product comprising:
a computer readable storage medium having computer readable program code embodied therewith, the computer readable program code comprising:
computer readable program code configured to generate, by a computer system, a monitoring-level process model, wherein the monitoring-level process model comprises a monitoring-level view of a process and being associated with an implementation-level process model, and wherein the implementation-level process model comprises a series of implementation-level steps to perform the process;
computer readable program code configured to receive a selection of a monitoring-level step in the monitoring-level process model;
computer readable program code configured to receive a selection of at least one implementation-level step in the implementation-level process model; and
computer readable program code configured to associate the at least one implementation-level step with the monitoring-level step.

15. The computer program product of claim 14, further comprising:
computer readable program code configured to identify at least one monitoring-level instance identifier for the monitoring-level process;
computer readable program code configured to present a list of definitions of process variables or other parameters of the implementation-level process; and
computer readable program code configured to receive a selection of a process variable for each monitoring-level instance identifier.

16. The computer program product of claim 15, further comprising computer readable program code configured to present a monitoring-level process instance to a user to display a status of steps the monitoring-level process instance to the user, wherein the monitoring-level process model is capable of displaying the state of an instance of this process, and wherein the monitoring-level instance identifier comprises an identifier which indicates what monitoring-level process instance to be displayed.

17. The computer program product of claim 15, further comprising computer readable program code configured to present each step of the monitoring-level process as a graphical representation of one or more implementation-level steps.

18. A method for process monitoring, the method comprising:
generating, by a computer system, a monitoring-level process model, wherein the monitoring-level process model comprises a monitoring-level view of a process and being associated with an implementation-level process model, and wherein the implementation-level process model comprises a series of implementation-level steps to perform the process;
receiving a selection of a monitoring-level step in the monitoring-level process model;
receiving a selection of event points defined in the implementation-level process models that signal a change in status of the monitoring-level step; and
associating the change in status of the monitoring-level step and the corresponding event points.

19. The method of claim 18, further comprising:
identifying at least one monitoring-level instance identifier for the monitoring-level process;
presenting a list of fields in the data structures of events that are sent at the selected event points of the implementation-level process; and
receiving a selection of a field for each monitoring-level instance identifier.

20. The method of claim 18, further comprising:
selecting at least one monitoring-level process to monitor;
selecting a high-process identifier for a desired monitoring-level process instance to present; and
presenting the monitoring-level process instance by showing the execution state of its steps to the user.
